(19) United States
(12) Patent Application Publication
(10) Pub. No.: US 2016/0107433 A1
(43) Pub. Date: Apr. 21, 2016

(54) Apparatus and method for removal of a segment of a layer of a multi-layer laminate

(71) Applicant: Jack A. Ekchian, Belmont, MA (US)

(72) Inventor: Jack A. Ekchian, Belmont, MA (US)

(21) Appl. No.: 14/520,333

(22) Filed: Oct. 21, 2014

(51) Int. Cl. B32B 38/10

(52) U.S. Cl. CPC B32B 38/10; B32B 2311/12

(57) ABSTRACT

Apparatus and method are disclosed that are used to precisely remove segments of one or more layers of a laminate to expose a portion of a targeted interior layer.

Resistance measurements between a point in the laminate where material is being removed and a second point in the laminate are used to control the removal process.

### CROSS-REFERENCE TO RELATED APPLICATIONS

This application claims priority of U.S. Provisional Patent Application No. 61/893,990, filed Oct. 22, 2013, entitled “Apparatus and method for removal of a segment of a layer of a multi-layer laminate” the contents of which are hereby incorporated herein by reference in their entirety.

### FIELD

The present invention relates generally to power tools and tool bits. The invention has particular application in stripping away portions of one or more layers of a laminate in order to expose a desired portion of a targeted interior layer.

### BACKGROUND OF INVENTION

Laminations comprising layers of the same or different materials are used in the construction of various items for a number of reasons. For example, beams made of laminated veneer lumber (lvl) are commonly recognized to be stronger than conventional lumber of the same dimensions. Conventional electrical wires and cables typically are laminates as well and comprise an inner conductor covered by one or more insulating layers. Laminates are now frequently used in the manufacture of flexible printed circuit boards and flat cables. Flat cables may be used instead of conventional communication cables, such as HDMI cables, as well as power supply cables such as extension cords. Flat cables have a much lower profile than conventional cables and can more easily be blended into the surface of walls and under or around obstructions.

Flat cables typically are comprised of very thin alternating layers of conductive and insulating materials. However, because the layers are thin, it is difficult to strip away unwanted layers of, for example, an insulating material in order to expose and make electrical contact with a targeted conductive layer. Conventional wire stripping tools are not effective in quickly removing a segment of one or more layers of a flat cable without damaging the other layers that are beneath the layer or layers being partially removed.

### SUMMARY OF THE INVENTION

It is an object of this invention to provide a method and an apparatus for removing a limited segment of one or more layers of a laminate to expose an inner targeted layer by using a tool bit without damaging any remaining layers. During the removal process, the electrical resistance between two or more points in the laminate is monitored. Tool bits may be rotary tool bits or non-rotary tool bits. The electrical conductivity or resistance may be measured between, for example, two points on the surface being contacted by the tool bit. This measurement is made using two or more tool face contacts. Alternatively, the electrical conductivity or resistance may be measured between a point or points on the surface being contacted by the tool bit and another point that is at a convenient distance from the tool bit. It is also an object of this invention to use resistance or conductivity measurements to control the amount of material being removed and/or the rate at which material is removed by the tool bit.

It is another object of the invention to remove a segment of one or more layers of a flat electrical or communication cable so that a certain area of the surface of a conductive, internal targeted layer is exposed.

It is a further object of this invention to provide a tool kit for removing segments of layers of a flat cable so that a selected segment of a conductive targeted layer is exposed. The kit comprises a tool bit with one or more tool face contact sensor pins that are configured to make electrical contact with the surface of material being removed. Two or more tool face contact sensor pins may be used to measure the electrical resistance between two points on the surface where material is being removed, by the tool bit, during the removal process. Alternatively, one or more tool face contact sensor pin(s) may be used to measure the electrical resistance between one or more points on the surface where material is being removed and a point that is at a convenient distance from the tool bit where material is not being removed by the tool bit. As a further alternative, the tool face itself may be used as an electrical contact and used to measure the electrical resistance between the surface where material is being removed by the tool bit and a point that is at a convenient distance from the tool bit where material is not being removed by the tool bit. During the removal process, the electrical resistance between two or more selected points is monitored. Based on the value of the resistance measurements obtained, the material removal process is controlled to automatically interrupt or alter the speed of the removal process. Alternatively or additionally, the kit may be configured to inform the tool operator when a certain electrical resistance or change in electrical resistance is achieved. The operator may be informed by, for example, visual, tactile or auditory signals. For example, a light may be illuminated or an alarm sounded when a certain resistance or change in resistance is detected.

It is yet another object of the invention to provide a kit for the stripping of segments of one or more layers of a laminate where a guide/clamp mechanism is used to maintain a tool bit in a desired position relative to a surface of the laminate. Also provided is a power tool for driving the tool bit.

The tool kit may also be configured with a vacuum or compressed gas system to remove or blow away debris produced during the material removal process. It is preferred that such debris be removed from at least the points where resistance measurements are being made, i.e. the vicinity of the electrical tool face contact sensor pins.

It is a further object of this invention to mark a flat cable with markings as an aid for the proper relative positioning and alignment of a material removal tool bit and devices for guiding the tool bit during the removal process.

### BRIEF DESCRIPTION OF THE DRAWINGS

The foregoing summary, as well as the description of the embodiments of the invention, will be better understood when read in conjunction with the appended drawings. For the purpose of illustrating the embodiments of the present inventions, and to explain their operation, drawings of preferred embodiments and schematic illustrations are shown. It should be understood, however, that the invention is not limited to the precise arrangements, variants, structures, features, embodiments, aspects, methods, advantages, improvements and instrumentalities shown, and the arrangements, variants, structures, features, embodiments, aspects, methods, advantages, improvements and instrumentalities shown and/or described may be used singularly in the apparatus or method or may be used in combination with other arrangements, variants, structures, features, embodiments, aspects, methods and instrumentalities. In the drawings:

FIG. 1a is an illustration, showing a perspective view of a flat cable of the prior art, comprising two or three layers at various parts of the cable. FIG. 1b shows a cross-section view of the cable in FIG. 1a.

FIG. 2a is an illustration showing a side-view of an embodiment of a rotary tool bit with tool face contact sensor pins configured according to the invention. FIG. 2b shows a bottom view of the tool bit in FIG. 2a. FIG. 2c shows a partial cross-section side-view of the tool bit in FIG. 2a. FIG. 2d shows an enlarged view of the sectioned portion of FIG. 2c.

FIGS. 3a-3b are illustrations showing use of the tool bit of FIG. 2a at various stages of material removal from a three-layer lamination. FIG. 3a illustrates the tool bit placed against the three layer lamination with no material removed. FIG. 3b illustrates the lamination of FIG. 3a with a portion of the first layer partially removed. FIG. 3c illustrates the lamination of FIG. 3a with a portion of the first layer removed.

FIGS. 4a-4c are illustrations showing the tool bit of FIG. 2 at various stages of material removal in a 5-layer lamination. FIG. 4a show the lamination with a portion of the first layer removed. FIG. 4b show the lamination with a portion of the first, second and third layers removed. FIG. 4c shows lamination of FIG. 4b with the tool bit withdrawn exposing the desired target layer.

FIGS. 5a-5b are illustrations showing another embodiment of a rotary tool bit configured according to the invention. FIG. 5a shows an illustration of a rotary tool bit which comprises two mutually insulated electrically conductive cutters. FIG. 5b shows an illustration of the tool bit of FIG. 5a where the head is shown in partial section.

FIGS. 6a-6b are illustrations showing an embodiment of a layer removal tool kit configured according to the invention. FIG. 6a shows the tool bit engaged in a clamp/guide mechanism. FIG. 6b shows the tool bit retracted from the clamp/guide mechanism.

FIG. 7a is an illustration showing yet another embodiment of a layer removal tool bit configured according to the invention comprising a tool face sensor pin and a remote contact.

FIG. 7b is an illustration showing still another embodiment of a layer removal tool bit configured according to the invention comprising a conductive tool bit and a remote contact.

FIG. 8 is an illustration showing an embodiment of a material removal system configured according to the invention comprising a clamp/guide mechanism, a rotary tool bit and a power tool for driving and controlling the tool bit.

FIGS. 9a-9c are illustrations showing still another embodiment of a material removal kit configured according to the invention comprising a clamp/guide mechanism and a rotary tool bit. FIG. 9a illustrates a partial cross-section side-view of a kit with a tool bit and clamp/guide mechanism. FIG. 9b illustrates the kit in FIG. 9a with a tool bit engaged in the clamp/guide mechanism and a portion of a layer of the laminate removed by the tool bit. FIG. 9c shows a top-view of the kit of FIG. 9b.

FIG. 10 is an illustration showing an embodiment of a flat cable configured according to an aspect of the invention.

### DETAILED DESCRIPTION

Certain exemplary embodiments will now be described to provide an overall understanding of the principles of the structure, function, manufacture and use of the apparatus and methods disclosed herein. One or more examples of these embodiments are illustrated in the accompanying drawings and described herein. Those of ordinary skill in the art will understand that the apparatus, methods and examples described herein and illustrated in the accompanying drawings are non-limiting exemplary embodiments and that the scope of the present invention is defined solely by the claims. The features illustrated or described in connection with one exemplary embodiment may be combined with features of other embodiments and that the features may be used individually, singularly and/or in various combinations. Such modifications and variations are intended to be included within the scope of the present invention.

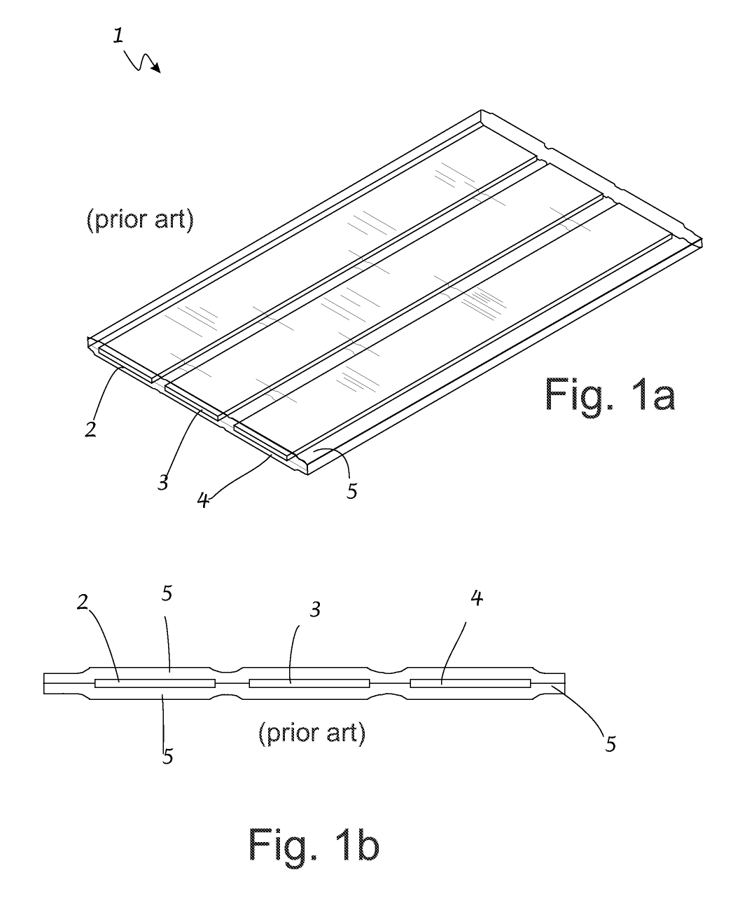

FIG. 1a illustrates a perspective view of a prior art flat cable 1 with three mutually insulated conductors 2, 3 and 4 and an insulating material 5. FIG. 1b shows the sectional end view of the cable in FIG. 1a. Certain regions of the cable comprise three layer laminations of a conductor sandwiched between two insulating layers. In other regions of the cable, the lamination comprises only two layers. U.S. Pat. Nos. 3,168,617; 3,547,718; 4,219,928; 4,695,679; 4,698,457; 4,864,081; 5,250,127; 5,274,195; 6,276,502; 6,492,595; and 8,237,051, which describe various flat cables, are incorporated herein by reference in their entirety.

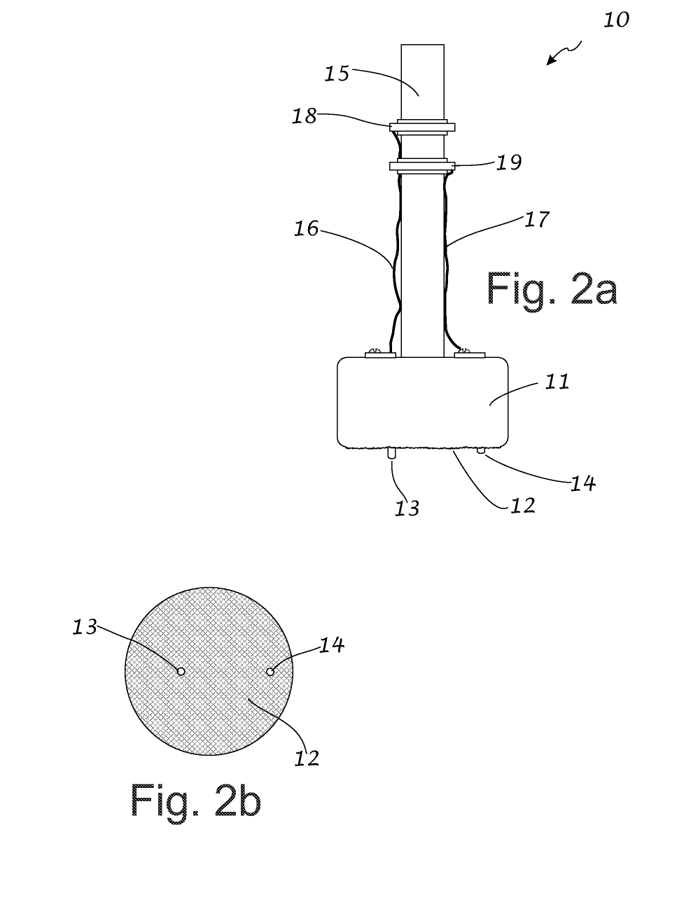

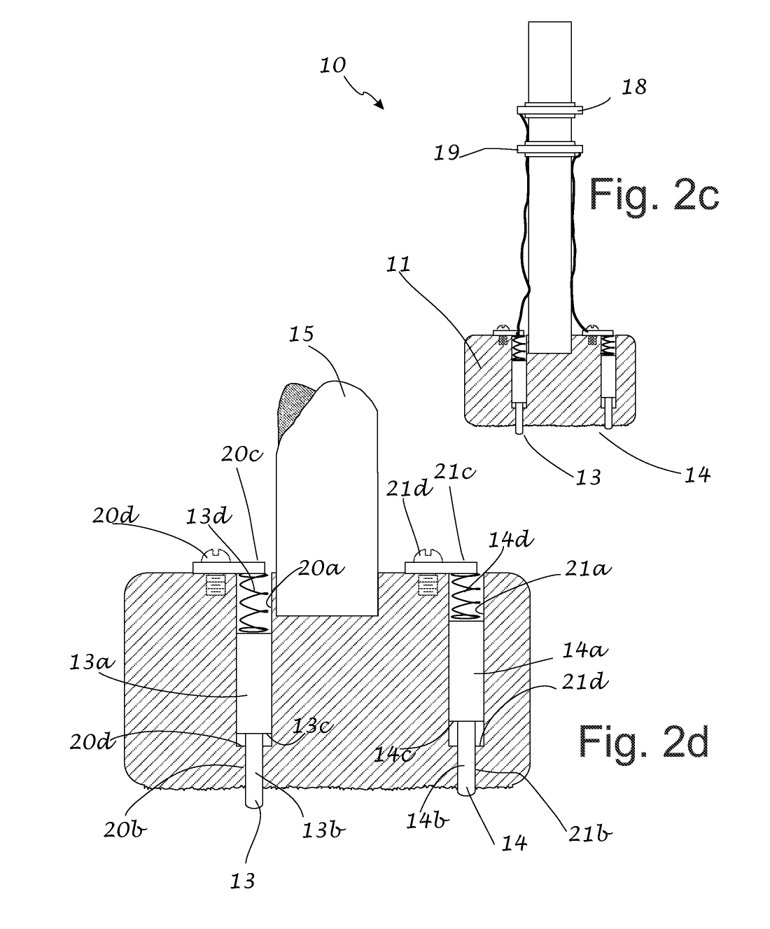

FIG. 2a illustrates a layer removal or stripping rotary tool bit 10 comprising head 11, abrasive face 12 and mutually insulated tool face contact sensor pin 13 and tool face contact sensor pin 14. The head 11 is preferably made of insulating material or materials, although conductive materials may be used so long as the tool face contact sensor pins are electrically mutually insulated. Shank 15 is attached to head 11. Tool face contact sensor pins 13 and 14 retract into head 11 when the bit is placed against a flat surface, but maintain electrical contact with the surface. Conductor 16 electrically conductively connects tool face contact sensor pin 13 with ring 18. Conductor 17 electrically conductively connects tool face contact sensor pin 14 with ring 19. FIG. 2b is an illustration showing the bottom view of rotary tool bit 10 and abrasive face 12 and the tips of tool face contact sensor pins 13 and 14.

FIG. 2c shows a partial cross section of the rotary tool bit 10 shown in FIG. 2a and FIG. 2b. FIG. 2d shows an enlarged view of the sectioned portion of FIG. 2c. Tool face contact sensor pin 13 comprises contact sensor pin body 13a and contact sensor pin neck 13b with intervening annular shoulder 13c. Similarly, tool face contact sensor pin 14 is configured with contact sensor pin body 14a and contact sensor pin neck 14b with intervening annular shoulder 14c. The tool face contact sensor pins are mutually insulated and are preferably manufactured from conductive materials and are more preferably manufactured from metals. Head 11 is preferably manufactured from insulating materials. Contact sensor pin bodies 13a and 14a are retractably received in bore 20a and bore 21a respectively, while contact sensor pin necks 13b and 14b, are respectively received in bore 20b and bore 21b. Electrically conductive spring 13d is disposed in bore 20a between the end of contact sensor pin body 13a and stop 20c to bias the pin to its fully extended position. Electrically conductive spring 14d is disposed in bore 21a between the end of contact sensor pin body 14a and stop 21c to bias the pin to its fully extended position. In their fully extended positions, the annular shoulders 13c and 14c rest against the intervening annular shoulders 20d and 21d between the larger and smaller diameter bores. Alternatively, tool bit 10 and head 11 may be manufactured from conductive materials so long as the tool face contact pins are insulated from each other and from the tool bit.

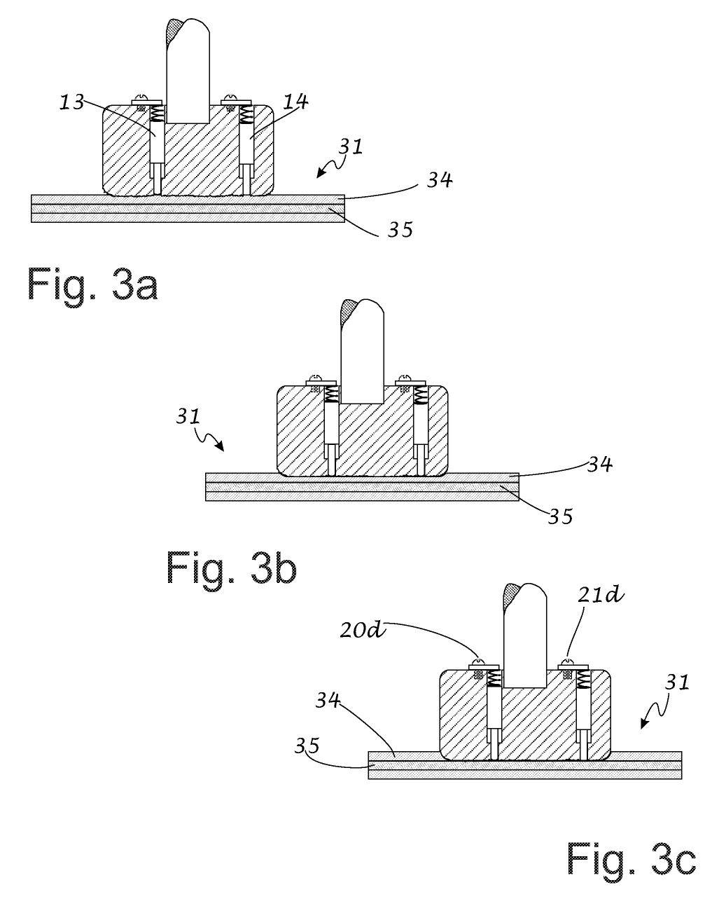

FIGS. 3a-3b illustrate the use of a rotary tool bit for the removal of a segment of a layer of laminate 31. The tool bit and laminate are shown in partial section and section respectively. In FIG. 3a, the tool bit is placed against the three layer lamination and tool face contact sensor pins 13 and 14 come in contact with surface of layer 34. FIG. 3b shows that layer 34 has been partially removed. FIG. 3c shows that the tool bit has removed all of the intervening segment of layer 34 that is located between the tool face and targeted layer 35. Tool face contact sensor pins are in direct electrical contact with layer 35. By monitoring the resistance between screw terminals 20d and 21d, the point at which the tool bit penetrates through layer 34 and comes into electrical contact with target layer 35 can be determined if the conductivity of layers 34 and 35 are different from each other. For example, if laminate 31 is comprised of copper targeted layer 35 and insulating layer 34, the precise point at which the tool bit has removed the intervening segment of the insulation between the tool and the copper layer can be determined by monitoring the resistance between screw terminals 20d and 21d.

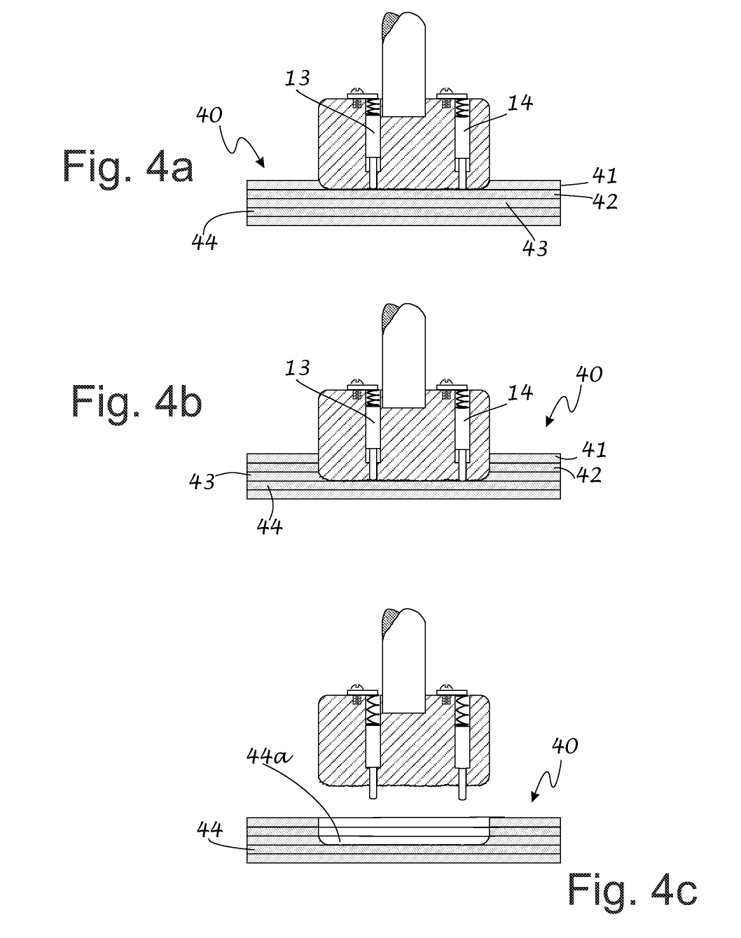

FIGS. 4a-4c show illustrations of the tool bit 10 of FIG. 2 being used to remove multiple layers of laminate 40. The tool bit and laminate are shown in partial section and section respectively. FIG. 4a shows that tool bit 10 has penetrated layer 41 and that tool face contact sensor pins 13 and 14 are in physical contact with a surface of layer 42. FIG. 4b shows that the tool face has penetrated layers 41, 42 and 43 such that tool face contact sensor pins 13 and 14 are in electrical contact with a surface of target layer 44. FIG. 4c shows that the tool bit 10 has been withdrawn exposing surface 44a of target layer 44. The tool face contact sensor pins 13 and 14 are in their fully extended positions. It is preferred that the difference in conductivity between the target layer and at least the last layer to be removed is large. For example, it is preferred that the difference be comparable to what is typically considered to be the difference in conductivity of a conductor of electricity and an insulator. However, such a larger difference is not necessary and even minor differences in conductivity are sufficient.

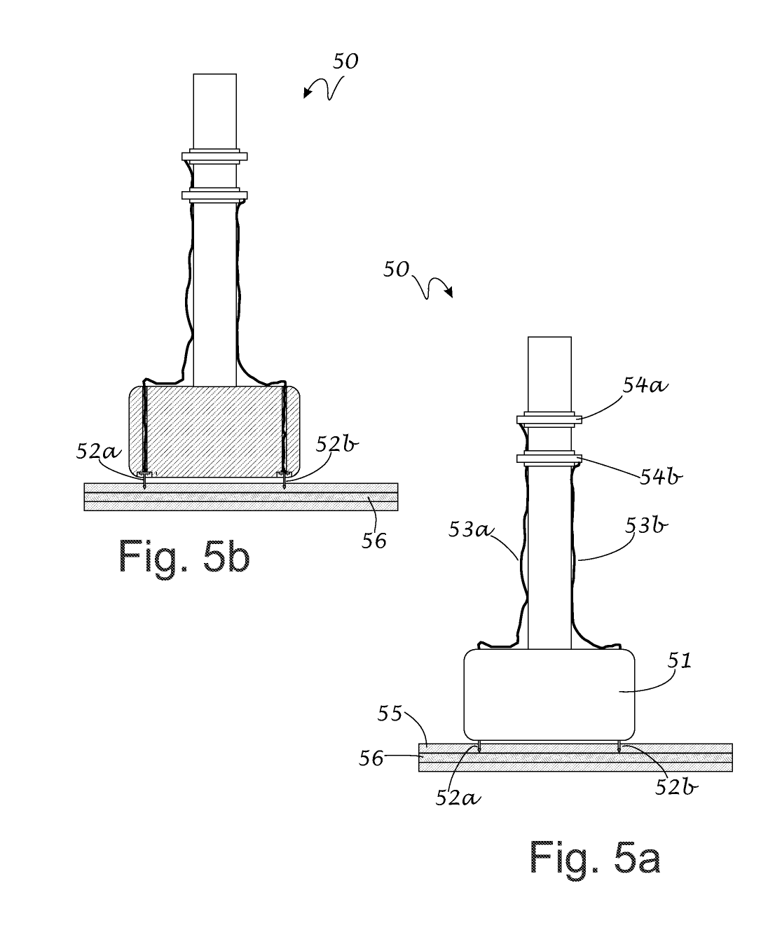

FIG. 5a shows an illustration of a rotary tool bit 50 with tool bit head 51 which comprises two mutually insulated electrically conductive cutters 52a and 52b. Conductor 53a electrically connects cutter 52a with ring 54a. Conductor 53b electrically connects cutter 52b with ring 54b. It is preferred that conductors 53a and 53b be insulated wires. FIG. 5b shows an illustration of the tool bit of FIG. 5a where the head is shown in partial section. By rotating tool bit 50 about its longitudinal axis, cutters will make a cylindrical cut in layer 55, eventually contacting surface or targeted layer 56. If layers 55 and 56 have different conductivities, the point when the cutters contact target layer 56 can be determined by monitoring the resistance between ring 54a and 54b.

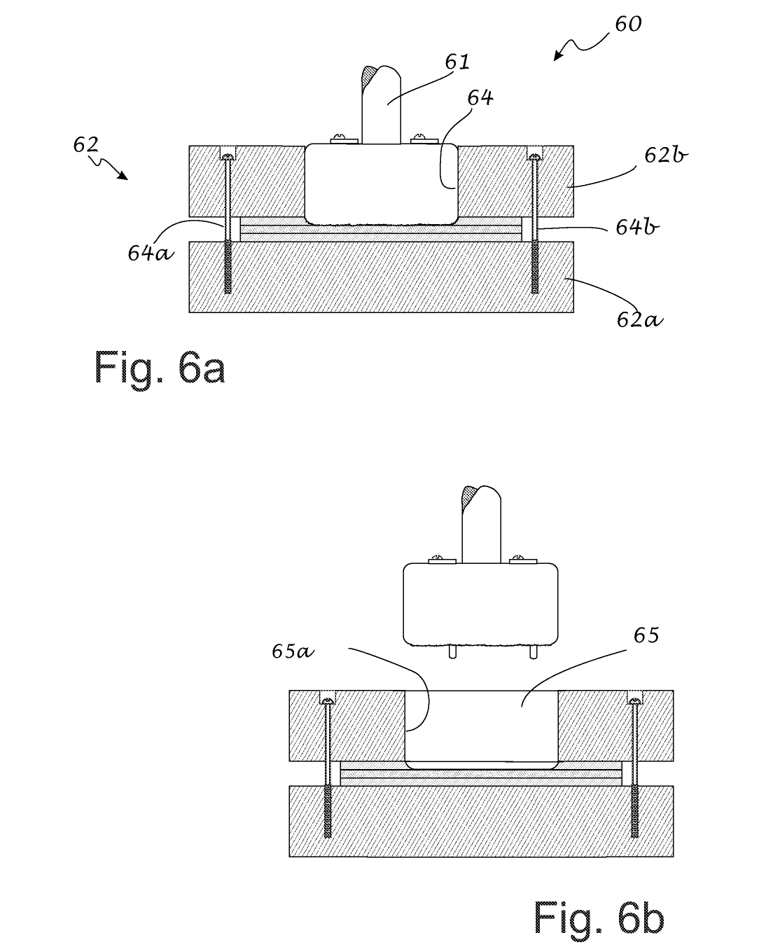

FIG. 6a illustrates kit 60 comprising the tool bit 61 (also shown in FIG. 2) and clamp/guide mechanism 62 configured to securely hold laminate 63 and to properly position the tool bit relative to the laminate. The laminate and the clamp/guide mechanism are shown in section. Screws 64a and 64b are configured to securely clamp the two pieces 62a and 62b of the clamping/guide mechanism to each other. Other attachment devices, such as for example, quick disconnect clamps or C-clamps may be used in place of or in addition to the screws. FIG. 6b illustrates the elements of the layer removal bit shown in FIG. 6a where the tool bit has been withdrawn from the clamp/guide mechanism. Opening 65 and bore 65a are configured to rotatably receive tool bit 61. It is preferred that the bore 65a of opening 65 have a diameter that is between 0.001 and 0.003 inches greater than the diameter of the cylindrical portion of the head of the tool bit 61.

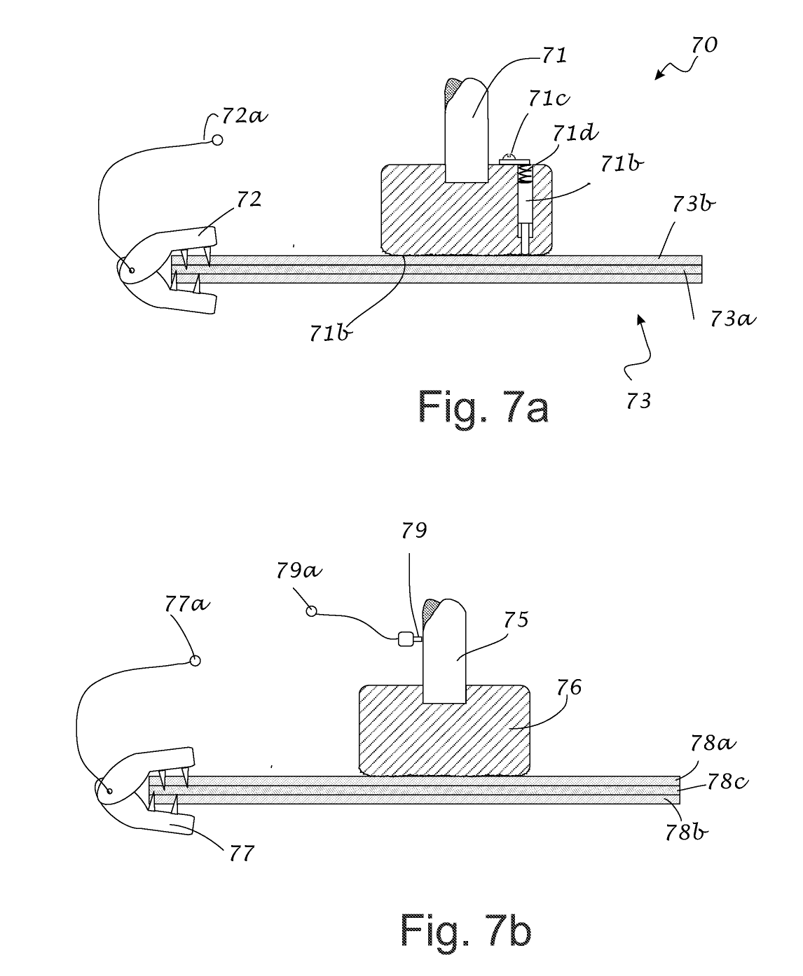

FIG. 7a illustrates a kit 70 comprising a rotary tool bit 71 comprising an abrasive face 71a and barbed clamp 72 attached to laminate 73. Tool bit head 71b and laminate are shown in section. Barbed clamp 72 is used to make electrical contact with targeted layer 73a of laminate 73 at a point that is at a convenient distance from the tool bit 71.

Tool bit 71 comprises at least one tool face contact sensor pin 71b configured to make electrical contact with the laminate 73. Layer 73b is an insulating layer, while layer 73a has a conductivity that is higher than the conductivity of layer 73b. By monitoring the resistance between electrical terminals 71c and 72a, it can be determined when contact sensor pin 71b comes into electrical contact with layer 73a. It is preferred that the conductivity of layer 73a be substantially different than the conductivity of layer 73b.

FIG. 7b shows another tool kit comprising tool bit 75 with head 76 and shank 76b. Head 76 and shank 76b are manufactured of a conductive material, preferably of highly conductive material such as, for example steel or brass. The resistance between the tool bit head and barbed jaw clip 77 is monitored. Electrical contact 79 makes continuous contact with conductive shank 75. For example, if layer 78a and layer 78b are insulating and layer 78c is conductive, the resistance between the terminal bit 79a and terminal 77a will change from a higher value to a lower value when the face of the tool bit 75 comes into contact with a surface of conductive layer 78c.

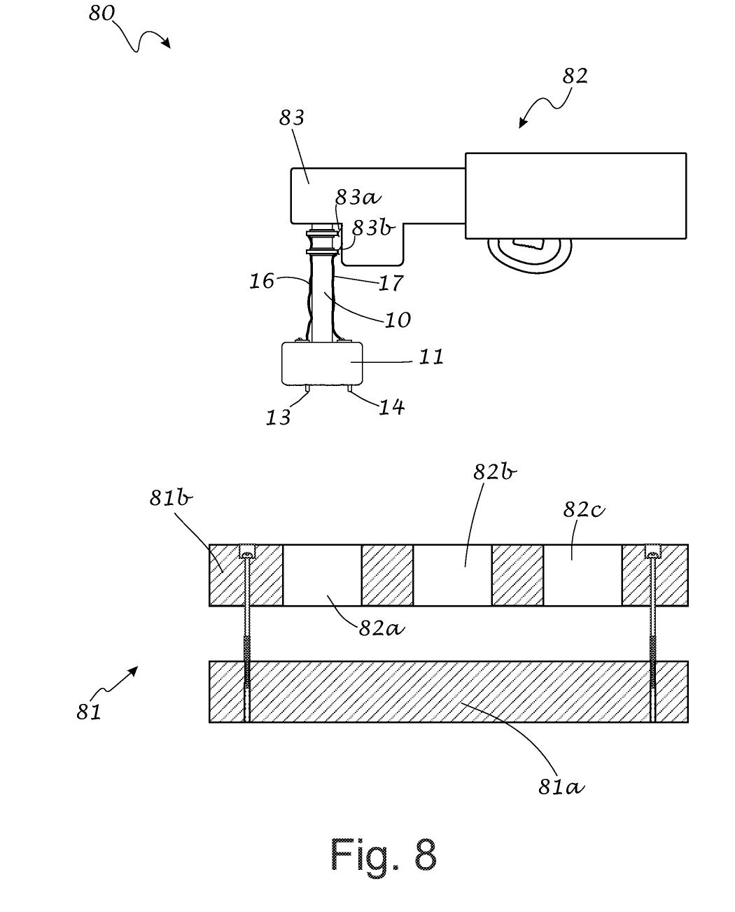

FIG. 8 illustrates layer removal system 80 which comprises tool bit 10 (also shown in FIG. 2a), a three opening clamp/guide mechanism 81 and a handheld, cordless power tool 82.

Power tool 82 comprises a drive section 83 configured to receive and grip shank of tool bit 10. Brush 83a is electrically conductively connected to tool face contact sensor pin 13 by means of conductor 16 and ring 18. Brush 83b is electrically conductively connected to tool face contact sensor pin 14 by means of conductor 17 and ring 19. The resistance between brushes 83a and 83b is monitored by the system during the material removal process. This resistance is substantially determined by the conductivity of the material that bridges the gap between tool face contact sensor pin 13 and tool face contact sensor pin 14. If the material is insulating, the overall resistance will be high. If the material is conductive, for example, if the gap is bridged by a metal surface, the overall resistance will be low. The operation of the tool bit 10 may be controlled by the system based on the measured resistance between brushes 83a and 83b. It is preferred that power tool 82 further comprise an automatic clutch mechanism or other device to automatically stop or curtail the rotation of bit 10. The devices for automatically stopping or curtailing the rotation of the bit are controlled based on the resistance detected between tool face contact sensor pins 13 and 14.

Clamping mechanism 81 has a lower support plate 81a and guide plate 81b comprising three opening 82a, 82b and 82c which are configured to rotatably receive head 11 of bit 10. Laminates may be clamped between support plate 81a and guide plate 81b. Bit 10 may then be placed in, for example, opening 82a and rotated about its longitudinal axis by power tool 82. When the resistance measured between the brushes is within a certain predetermined range, the power tool automatically stops or slows the rotation of the tool bit. One or more layers of a laminate may be removed by this procedure.

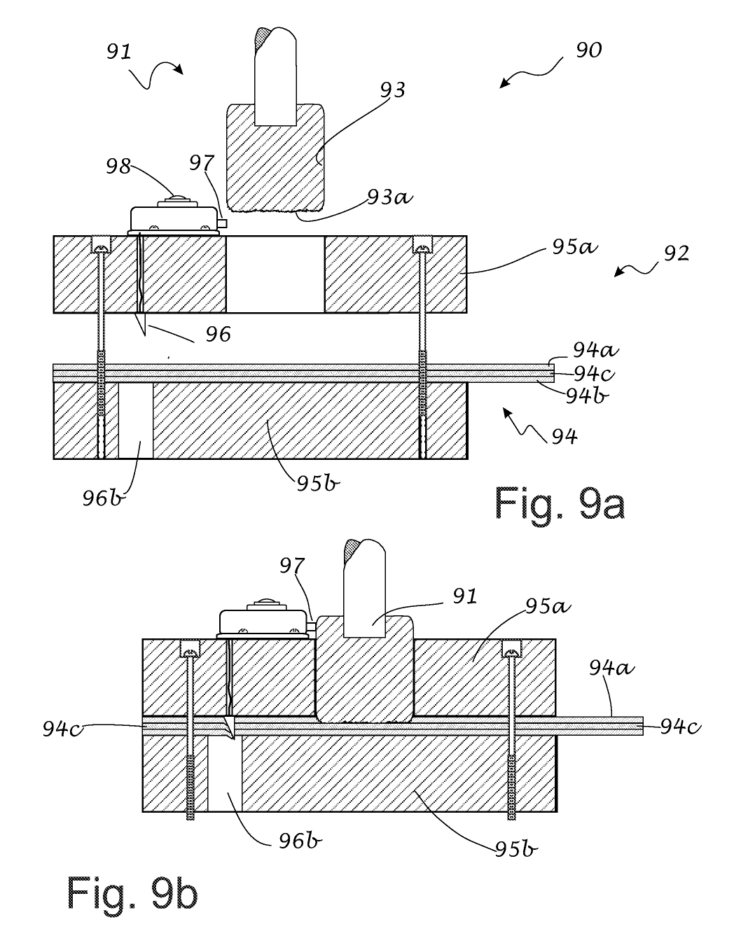

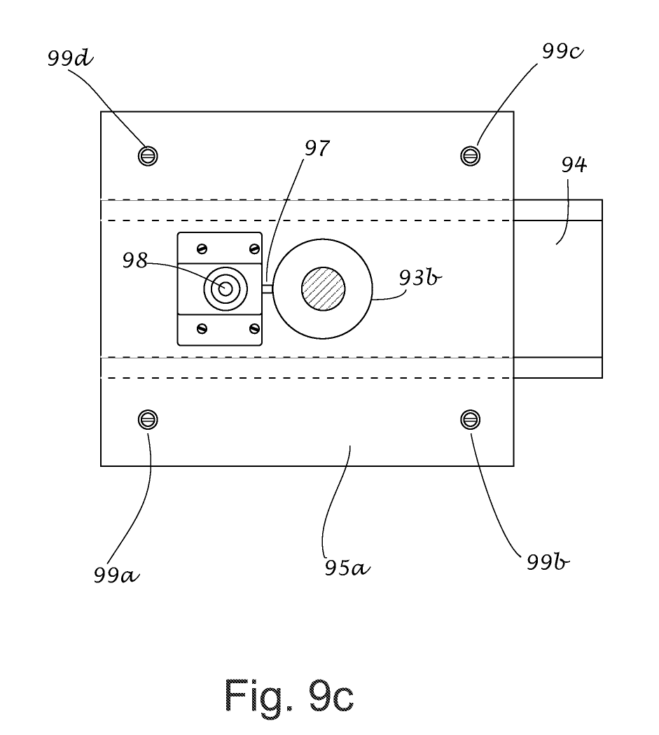

FIG. 9a illustrates kit 90 which comprises tool bit 91 and clamp/guide mechanism 92. Tool bit 91 comprises conductive head 93 with abrasive face 93a. Alternatively, the face of the tool bit head may have cutting blades such as an end-mill or a Forstner bit. If a Forstner bit is used, it is preferred that the centering brad be eliminated. U.S. Pat. Nos. 5,695,304 and 6,354,774, which describe various Forstner bits, are incorporated herein by reference in their entirety. A conventional power tool, such as an electrical hand drill or drill press (not shown), may be used to drive the tool bit 91.

Laminate 94 comprises insulating layers 94a and 94b and conductive layer 94c. Upper clamp/guide mechanism 95a comprises spike 96, electrical contact 97, and indicator light 98. The indicator light is illuminated when the electrical resistance between spike 96 and contact 97 comes within a predetermined range. Alternatively, the light may be illuminated when the spikes 96 and tool bit 91 come into electrical contact with the same metal layer. The lower clamp/guide mechanism 95b comprises cavity 96b that is configured to receive spike 96 and any displaced or severed pieces of laminate 94.

FIG. 9b illustrates kit 90, where the tool bit 91 has penetrated through insulating layer 94a and contacted the upper surface of targeted conductive layer 94c. Spike 96 has also penetrated the nonconductive layer 94b and come into electrical contact with conductive layer 94c. Electrical contact 97 makes electrical contact with the cylindrical section of head 93. The head 93 is conductive and when it electrically contacts the exposed surface of targeted layer 94c it completes the circuit between spike 96 and contact 97 and causes indicator light 98 to be illuminated. FIG. 9c illustrates a top view of upper clamp/guide mechanism 95a shown in FIGS. 9a and 9b. Electrical contact 97 is electrically connected to cylindrical surface 93b of tool bit 10. FIG. 9c shows a top view of indicator light 98, laminate 94, and clamping screws 99a, 99b, 99c and 99d.

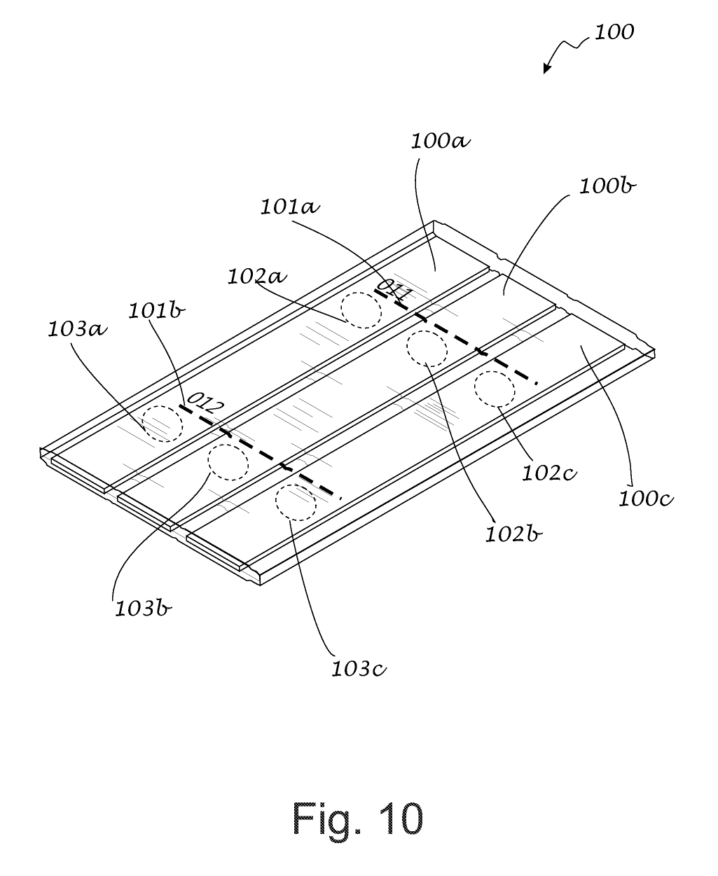

FIG. 10 illustrates a laminate 100 with conductors 100a, 100b, and 100c. The laminate is marked with positioning lines 101a and 101b and positioning circles 102a, 102b and 102c and 103a, 103b and 103c. The positioning lines and circles are preferably marked on the surface of laminate 100 at desired regular intervals. Markings may be dashed or solid lines of any convenient color. The lines may be used to properly locate clamp/guide mechanisms relative to the laminate.

The invention has been described in terms of functional principles and illustrations of specific embodiments. Embodiments described herein, including descriptions of the figures, are merely intended as exemplary, but the concept of the invention is not limited to these embodiments. The following claims are not limited to or by the described illustrative embodiments, figures, and stated objectives of the invention or the abstract. Furthermore, various presently unforeseen or unanticipated combinations of the disclosed embodiments, or their elements, or alternatives, variations or improvements which may become apparent to those of skill in the art are also intended to be encompassed by the following claims.

What is claimed is:

1. A method for removing a segment of a layer of a laminate to partially expose an targeted interior layer, comprising:
using a tool bit to remove material from a surface of said laminate;
measuring the resistance between a point on the surface where material is being removed and a second point on a layer of said laminate;
continuing to remove material until the resistance measurement falls within a prescribed range.

2. The method of claim 1 wherein at least one layer of the laminate is metal.

3. The method of claim 2 wherein the at least one metal layer is copper.

4. The method of claim 1 wherein the second point is on the surface where material is being removed by said tool bit.
